(19) United States
(12) Patent Application Publication
(10) Pub. No.: US 2007/0130004 A1
(43) Pub. Date: Jun. 7, 2007

(54) AD campaign optimization

(75) Inventors: Christian H. Borgs, Seattle, WA (US); Jennifer T. Chayes, Seattle, WA (US); David M. Chickering, Bellevue, WA (US); Seyed Omid Etesami, Berkeley, CA (US); Nicole S. Immorlica, Seattle, WA (US); Kamal Jain, Bellevue, WA (US); Mohammad Mahdian, Bellevue, WA (US); Christopher A. Meek, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/291,886

(22) Filed: Dec. 1, 2005

(51) Int. Cl. G06Q 30/00

(52) U.S. Cl. 705/14

(57) ABSTRACT

The subject disclosure pertains to systems and methods that optimize advertisement campaigns. In particular, total utility that can be derived by an advertiser given particular keywords is maximized. The price of each keyword/slot pair can be determined or estimated and bids adjusted automatically to maximize advertiser utility or return on investment for a campaign.

### BACKGROUND

Keyword advertising is an increasingly popular advertisement medium for both traditional and online businesses. Keyword or pay-per-click advertising is a technique employed to direct users to particular websites. Among other technologies, keyword advertisements can be employed in conjunction with search engines. Search engines receive queries and employ complex mechanisms such as neural networks to retrieve relative results for a query. In addition to query results, advertisements associated with one or more keywords of a query can be produced. Accordingly, a portion of a webpage can be designated for search results and another portion can display advertisements. These advertisements are trigged and displayed based on keywords or phrases selected by advertisers. Advertisements typically include an ad title, text, and address. The ad title and text are utilized to identify and describe a product or service. These advertisement portions are designed to entice a user to click on the advertisement. The address can be a uniform resource locator that specifies a link to let the user know where they will be taken upon clicking on the ad.

Keyword advertising has significant advantages over conventional advertisement mediums. First, advertisements are distributed on massive scale such that millions people can view particular ads per month. More importantly, the ads are provided at a time likely to have the most impact, namely when a user is shopping for a product or service. The advertisements can also be targeted to particular users, regions, and/or locations to increase overall return on investment. Another significant advantage of keyword advertising is cost. In particular, an advertiser does not pay unless a user clicks on an advertisement and is transported to an advertiser's website. Display of the advertisements alone costs nothing. Additionally, keyword advertising is flexible in that it can be managed twenty-four hours a day by people without advanced marketing and/or computer science degrees. Advertising space is purchased by auction.

An ad auction is conducted to determine the allocation and the pricing of the advertisement space. Advertisers bid on particular keywords and/or phrases. Ads with higher bids have priority over lower bids and are given a better position. For example, the highest bid can be given the first position in a list of advertisements, while the lowest bid may not even be presented. Bids are conventionally based on a cost per click price model. A click corresponds to a user clicking on or selecting an advertisement. As previously mentioned, advertisers are not billed for ad impressions or presentation of an advertisement. Rather, they are charged when a user clicks on the ad and is directed to an advertiser's website. Based on their bid and ultimately the advertisement position, advertisers can increase their exposure and significantly improve traffic to their website.

Due to the nature of keyword advertising, controlling costs is particularly important. Costs can skyrocket based on the unknown including the number of clicks that will be received during a given period and the often unpredictable auction price charged per click. As it will be appreciated, costs can vary even more for a campaign including a plurality of keyword advertisements. To control advertising costs, mechanisms are available that enable advertisers to specify a monthly budget that is to be respected. More specifically, management tools exist that are designed to maximize the number clicks an advertiser receives given a target budget.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described the subject innovation pertains generally to advertisement systems and more particularly toward optimizing the total utility of advertisements to advertisers subject to budget constraints. The subject innovation recognizes that utility to advertisers may differ across keywords. For instance, advertisers may derive a greater benefit, for example in sales, from keyword A than then from keyword B. Conventional systems such as those that maximize the number of clicks per advertisement do not recognize varying utilities as all keywords are deemed to be of equal value. As a result, such systems are not concerned with maximizing utility with respect to a plurality of keywords in an ad campaign while also respecting a budget.

In accordance with an aspect of the subject innovation, a bid optimization system is provided that can be integrated within an advertisement system or communicatively coupled thereto as a non-native tool. The bid optimization system can generate bids or adjust provided advertiser bids to maximize utility of an advertiser with respect to numerous keywords of an ad campaign. Furthermore, the bid optimization system can also be employed to increase the revenue of the advertisement system such as an auction. Once one or more optimized or effective bids are generated, these bids can be provided to the advertisement system rather than original bids, if provided.

According to an aspect of the claimed subject mater, total utility of an advertiser can be optimized. This can be accomplished by determining or receiving the marginal utility for each keyword/slot pair and adjusting bids to increase and/or decrease the marginal utility of keywords to maximize the total utility.

In accordance with another aspect of the subject innovation, the return on investment (ROI) can be optimized. In this instance, ROI can be employed as an estimate of marginal utility. Utilizing this estimate, the ROI for an advertiser for each keyword can be equalized to maximize the total return on investment.

According to yet another aspect of the subject innovation, an intelligence component can be employed to produce data required to maximize total utility or return on investment. More particularly, artificial intelligence, machine learning, and/or knowledge-based mechanisms can be utilized to generate advertisement statistics needed for computations. Additionally or alternatively, available data can be utilized to estimates such as bid ratios to approximate marginal utility.

In accordance with still another aspect of the claimed subject matter, bids (original or effective) can be perturbed slightly by an auction mechanism to prevent cycling and to converge on a good equilibrium when multiple users employ bid optimization. The bids can be adjusted or perturbed by adding a small random value to the bids.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a bid optimization system.

FIG. 2 is a block diagram of an analyzer component that employs marginal utility.

FIG. 3 is a block diagram of an analyzer component that utilizes return on investment as an estimate of marginal utility.

FIG. 4 is a block diagram of an analyzer component that employs an intelligence component to obtain data.

FIG. 5 is a block diagram of an analyzer component that includes a perturbance component.

FIG. 6 is a block diagram of an advertisement system that incorporates bid optimization.

FIG. 7 is a block diagram of an advertisement system with external bid optimization.

FIG. 8 is a block diagram of an exemplary system in which aspects of the subject innovation can be employed.

FIG. 9 is a flow chart diagram of a bid optimization method employing utilities.

FIG. 10 is a flow chart diagram of a bid optimization method utilizing return on investment.

FIG. 11 is a flow chart diagram of a bid optimization method that perturbs bids.

FIG. 12 is a schematic block diagram illustrating a suitable operating environment for aspects of the subject innovation.

FIG. 13 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DV) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

It should also be noted and appreciated that while various aspects of the subject invention are described with respect to an advertisement system that employs an auction, the subject innovation is not limited thereto. Disclosed aspects can also be employed with other types of systems such as those that employ prices. In such instances, bids can correspond to fixed price payment.

Further yet, various aspects of the innovation are described solely with respect to click-through pricing for purposes of brevity. However, it should be noted that other advertising pricing schemes are also contemplated and are to be considered within the scope of claimed subject matter including but not limited to billing upon impression (e.g. display) and/or acquisition (e.g., purchase of advertised good/service).

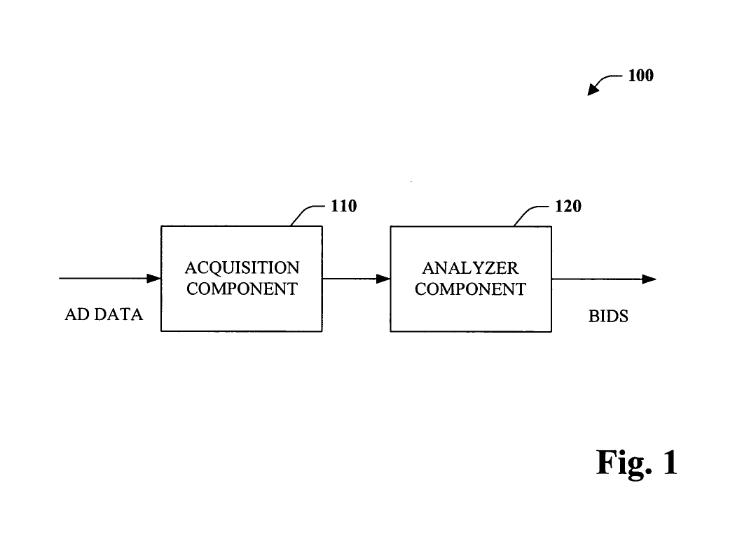

Turning initially to FIG. 1, a bid optimization system 100 is illustrated in accordance with an aspect of the subject innovation. Optimization system 100 includes an acquisition component 110 and an analysis component 120. The acquisition component 110 can receive, retrieve, or otherwise obtain or acquire advertising data. Advertising data can include data received from a user such as but not limited to keywords, bids, utility values and constraints (e.g., min/max bids, campaign budget . . . ). This data can be input by a user via a graphical user interface (GUI). Additionally or alternatively, a wizard can be employed to capture advertising data from a user by way of a series of sequential graphical interfaces windows. The acquisition component 110 can also capture advertising data from an advertising system such as current bids and price per slot for various keywords, number of searches for keywords, and click through rate (CTR), among other things. The acquisition component 110 is communicatively coupled to the analyzer component 120.

The analyzer component 120 optimizes advertising bids within a campaign. The analyzer component 120 can receive or retrieve data from the acquisition component 110 including advertisement campaign data such as keywords and one or more budget constraints. Based on this and other data, the analyzer component 120 can maximize the total utility of an advertiser for an ad campaign. Conventional systems are available that maximize the number of clicks of an advertiser. However, this does not maximize the utility of the advertiser as utility may differ across keywords and/or upon other factors including but not limited to time of day. In operation, the analyzer component 120 can determine or estimate the price for each keyword/slot pair and automatically adjust provided bids or generate new bids in order to purchase a cost effective slot. In one particular implementation, the analyzer component 120 can decrease bids on keywords that have low return so that the budget is not exhausted early and more is spent on high return words. Thus, advertisers can automatically refine their advertising campaigns to maximize utility.

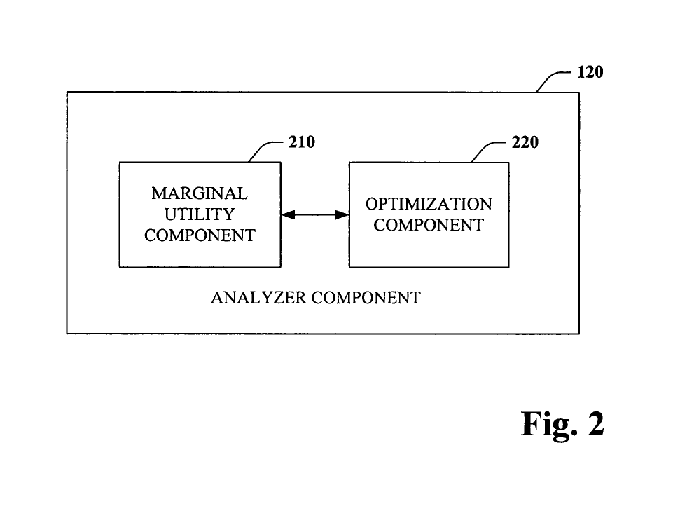

FIG. 2 illustrates the analyzer component 120 in further detail in accordance with one aspect of the provided subject matter. In particular, analyzer component 120 includes marginal utility component 210 and optimization component 220. The marginal utility component 210 can receive or retrieve the marginal utility associated with each keyword or ad. Alternatively, marginal utility component 210 can determine or compute this value base on other available data. Marginal utility corresponds to the derived benefit or utility an advertiser receives from display of an ad for a keyword. For example, this benefit can correspond to the number of sales or acquisitions generated for particular keywords. More specifically, the utility of an advertiser for a keyword can be defined as the total utility derived from ads being shown minus the total payment or cost for that keyword per unit of time such as day. The marginal utility provided by the marginal utility component 210 is transmitted to the optimization component 220.

The optimization component 220 receives or retrieves the marginal utility of each keyword or ad as well as other data and maximizes the overall utility of an advertiser. The optimization component 220 can modify provided bids or generate new effective bids for each keyword or ad. The marginal utility of each advertiser for various keywords is equalized by the optimization component 220. In other words, if the marginal utility of keyword i is less than the marginal utility of keyword j, then the optimization component 220 can improve total utility by increasing the bid on j and decreasing the bid on i, thereby decreasing the marginal utility for j and increasing the marginal utility for i. It should be noted that if the optimization component 220 can obtain all other prices and statistics concerning the number of searches for each keyword and the click through rate at different slots, among other things, computing the optimal bid and placement of ads is a knapsack-type problem (and hence NP-complete to solve exactly).

In addition to maximizing the overall utility of an advertiser, the optimization component 220 can be designed to increase revenue for an advertisement system such as a keyword auction. In such a situation, if the effective bid on at least one item is less than the original bid, then the budget of the advertiser can be exhausted. In other words, bids can be decreased for those advertisers who are constrained by their budget. This is not necessarily the optimal strategy for the advertiser. In fact if the marginal utility of the advertiser (aggregated over all items) at the value of their daily spending is negative, then it is better to underbid even if the budget is not exhausted. More precisely, at the optimum either the marginal utility of the advertiser is zero or the budget is exhausted. However, there are several reasons to ignore this issue. First, in practice, there is typically a tendency to submit bids that are less than the true utilities. Thus, the value at which the marginal utility is zero (with respect to true utilities) might be larger than what the computations of optimization component 220 show. Additionally, reducing the bids of advertisers that do not exhaust their budget would decrease revenue for the system. Still, further yet, many advertisers actually want to exhaust their budget.

It should also be noted that an optimization component 220 might also be prohibited from modifying a bid or generating an effective bid that is larger than an originally provided bid or a specified maximum bid. This provides advertisers with some degree of control or influence over bids, such as ensuring that they are not going to spend an exorbitant amount of money on a click for a single keyword, even if it is the optimal strategy.

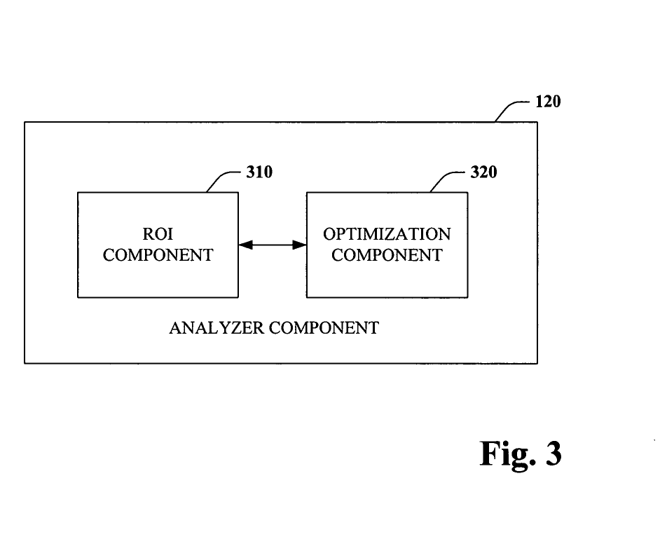

Turning to FIG. 3, analyzer component 120 is illustrated in accordance with an aspect of the subject innovation. Analyzer component 120 includes a return on investment (ROI) component 310 and optimization component 320. ROI component 310 determines or calculates return on investment for each keyword. Return on investment can be utilized as an estimate for marginal utility of an advertiser for each keyword. The ROI for a keyword is defined as the total utility that an advertiser derives from his ads on that keyword divided by the payment or cost of the keyword. Where the total utility derived by an advertiser is not specifically provided it can be determined or otherwise obtained via other data. For instance, the utility can be calculated based on the relative worth of bids or specified maximums. By way of example, if the maximum bid for the word “rose” is one dollar and the maximum bid for the word “daisy” is fifty cent then a click from the keyword “rose” is worth twice as much as a click coming from the word “daisy.”

There are at least two advantages of employing ROI instead of marginal utility. First, generation of ROI is much simpler. Second, an ROI-based algorithm is independent of the scaling of utility values. In other words, if the advertiser underbids for all keywords with the same ratio, the algorithm still behaves the same way. The ROI component 120 provides the ROI for each keyword to the optimization component 320

Optimization component 320 can maximize an advertiser's total return on investment. Similar to the optimization component 220, optimization component 320 can accomplish this goal by equalizing the ROI of the advertiser for each keyword. Where initial bids are provided, optimization component 320 can move a keyword to a slot higher or a slot lower to optimize ROI. To accomplish this objective, bids on keywords are either increased or decreased. There are at least two ways optimization component 320 can chose the keyword kᵢ that is to be moved up a slot. One way is select the keyword with the maximum ROI and the other is to pick the keyword for which the slot above it has the highest ROI. Similarly, to choose the keyword kⱼ that is to be moved down the optimization component can select the one with the lowest ROI or the one for which the slot that is to be moved to has the lower ROI. Optimization component 320 can move up keyword kᵢ if the budget is currently being under spent. Keyword kⱼ can be moved down if the budget is currently being overspent and after moving down kⱼ the budget is still being overspent. This can be determined utilizing statistics about the number of times each keyword becomes available during the rest of the day. The approach provided by optimization component 320 is advantageous at least in that it quickly finds the optimal allocation for an advertiser.

Alternatively, it is to be noted that optimization component 320 can employ an arbitrarily good approximation to the optimal solution using a dynamic program. For instance, suppose that there are m search words, and word i has nᵢ slots for advertisements. For 1≦i≦n, 1≦j≦nᵢ, let uᵢⱼ and cᵢⱼ be the utility and cost of the j'th slot of word i during a day to the advertiser (note, we assume the utility uᵢⱼ equals bᵢ*CTRᵢ the bid bᵢ of the advertiser for the i'th word times his CTR for that word). Assume that every word has a slot with zero utility and cost corresponding to not being displayed for that word. Optimization component 320 should choose jₗ, . . . , jₘ such that Σᵢuᵢⱼ_{ᵢ} is maximized subject to the budget constraint Σᵢcᵢⱼ_{ᵢ}≦B.

Let U be the maximum utility that one can receive from a single slot (not considering those slots that cost beyond the budget). Optimization component 320 can approximate uᵢⱼ by U′ᵢⱼ=U/k·floor(uᵢⱼ·k/U), where k is a large integer. Let U_{OPT} (respectively, U′_{OPT}) be the optimal total utilities when the utilities of the slots are uᵢⱼ (respectively u′ᵢⱼ). What results is: U_{OPT}−m·U/k≦U′_{OPT}≦U_{OPT}. Therefore, U′_{OPT} is a (1−E)-approximation for k=ceil(m/E).

Optimization component 320 can now compute U′_{OPT} efficiently by dynamic programming since the new utilities are multiplies of U/k: Let Aᵢᵤ be the minimum necessary budget to get utility u from words 1, . . . ,i , where 0≦i≦m and u=cU/k for 0≦c≦nk. The Aᵢᵤ array can be filled easily in polynomial time. The optimal utility U′_{OPT} is the largest u such that Aₘᵤ≦B.

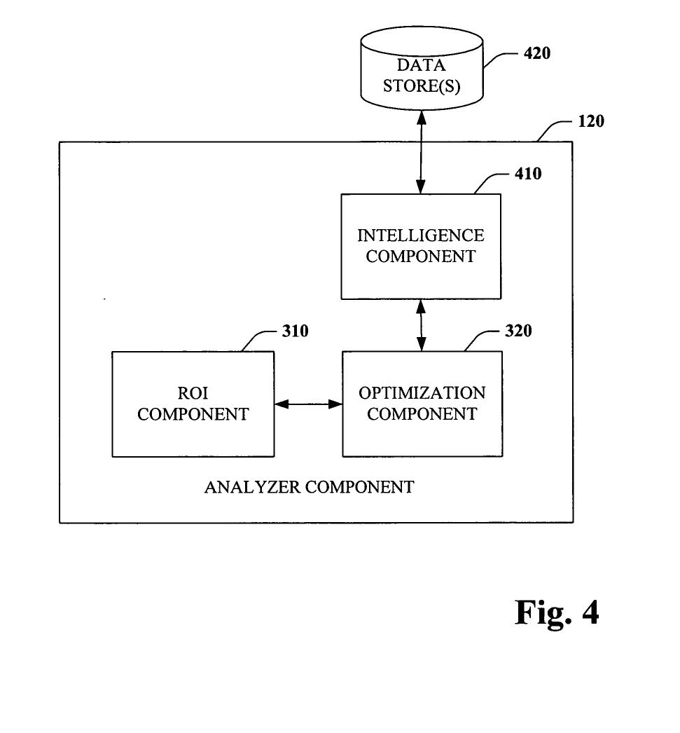

FIG. 4 depicts still another analyzer component 120 in accordance with an aspect of the subject innovation. The analyzer component 120 includes a ROI component 310 and an optimization component 320 as previously described with respect to FIG. 3. The analyzer component 120 also includes an intelligence component 410 communicatively coupled to the optimization component 320. There may be cases in which data that is required by the optimization component 320 has not been provided or is otherwise unknown. For example, the actual value of prices for keyword/slot pairs may not be known. Intelligence component 410 can generate or infer heuristically the required values, for example from past data (e.g., learned data) provided in one or more data stores 420.

Intelligence component 410 can be an artificial intelligence based component (e.g., machine learning, knowledge or rule based systems . . . ) employed in connection with performing inference and/or probabilistic determinations and/or statistical-based determinations. For example, the intelligence component 410 can infer or reasoning about states of a system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the intelligence component 410.

Additionally or alternatively, other approaches or techniques can be applied by optimization component 320 to effectively deal with a lack of information. For example, assume that the optimization component 320 only knows the information about the advertiser that it is trying to optimize for and nothing about other advertisers or prices for different slots. If some statistics are known about the availability of various keywords, the optimization component can gradually (e.g., by a small percentage) decrease bids on keywords that have low ROIs and gradually increase bids on keywords that have high ROIs. Alternatively, the optimization component can use the value of the bid as an estimate for the price that it has to pay to estimate the ROI of the slot that is being considered as part of a move.

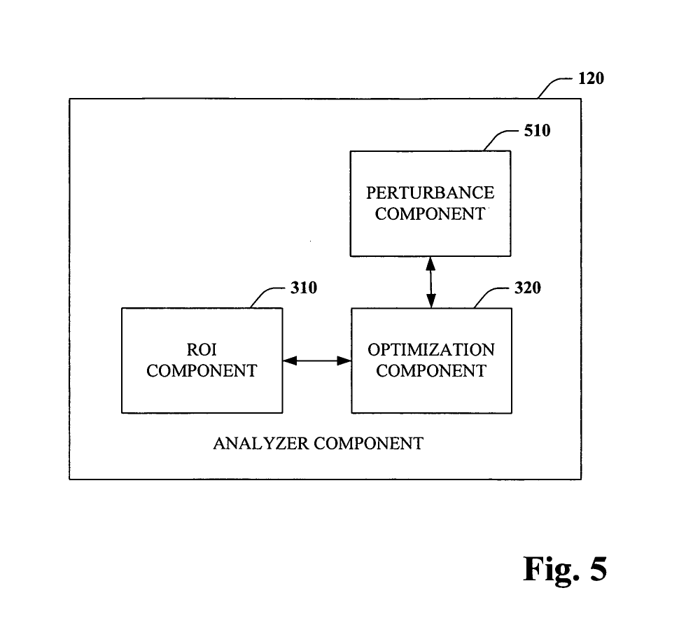

Turning to FIG. 5, yet another analyzer component 120 is depicted in accordance with an aspect of the subject innovation. The analyzer component 120 includes ROI component 310 and optimization component 320. As previously described, the ROI component 310 can be utilized to determine the return on investment for keywords. These values can then be transmitted to the optimization component 320 to optimize the total return on investment for a plurality of keywords in a campaign subject to any budget constraints. The analyzer component 120 can further include a perturbance component 510. Perturbance component 510 perturbs values of optimal or effective bids generated by the optimization component 120. The values of bids are slightly modified to, among other things, increase revenue for an auction system and prevent cycling or convergence on the same value. For instance, optimization component 320 can add a small negative random variable to each adjusted bid submitted. This allows the advertisement system to converge to a good equilibrium (e.g., one with high revenue) when multiple advertisers use the system.

In support the aforementioned claim regarding perturbance, suppose there are m advertisers and n words. The daily budget of advertiser i is Bᵢ, and the utility of advertiser i for showing his ad on word j is uᵢⱼ. On each day t, advertiser i bids a value bᵢⱼ(t) for the daylong possession of word j. When a search on word j occurs, the bids are perturbed as follows: b′ᵢⱼ=bᵢⱼ(t)·exp(Eᵢ), where Eᵢ is a random number in [−∂, 0], independently generated for each search, and ∂>0 is a small constant. Then a first-price auction is run with bids b′ᵢⱼ. Once an advertiser finishes his budget, he cannot further bid during that day.

Let sᵢ(t), a number in the set [0, Bᵢ], denote the spending of advertiser i on day t. Let eᵢ(t), a number in the set [0, 1], denote the moment during day t when advertiser i finishes his budget (or 1 if he does not finish his budget). Consider the following bidding algorithm for advertiser i: On day t, fix Rᵢ(t) in [0, 1] and bid bᵢⱼ(t)=Rᵢ(t)·uᵢⱼ. The value of Rᵢ(t) is determined by the following recurrence:

$${R}_{i} ( t + 1 ) = \begin{matrix}{R}_{i} ( t ) \cdot exp ( - E ) & if {e}_{i} ( t ) < 1 \\ {R}_{i} ( t ) \cdot exp ( E ) & if {s}_{i} ( t ) < {B}_{i} and {R}_{i} ( t ) \leq exp ( - E ) \\ {R}_{i} ( t ) & otherwise\end{matrix}$$

where E>0 is a small constant compared to ∂.

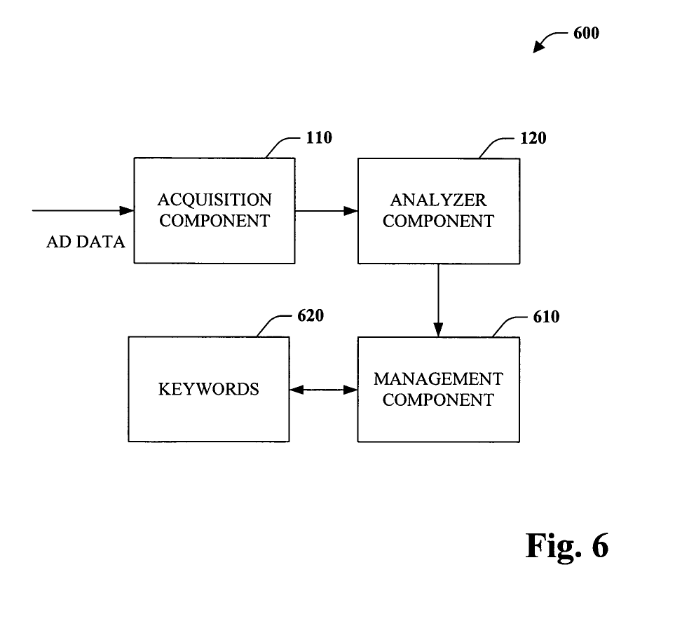

Referring to FIG. 6, an advertisement system 600 is disclosed in accordance with an aspect of the subject innovation. Advertisement system 600 includes the acquisition component 110 and analyzer component 120 that together form the bid optimization system 100 of FIG. 1 described supra. In brief, the acquisition component 110 can receive keyword advertising data such as keywords, bids, constraints, prices, and click through rate to name a few. The analyzer component 120 receives and utilizes this information to modify and/or generate bids for keywords in an ad campaign that maximize utility or an estimate thereof for advertisers given a specific budget. The analyzer component 120 is communicatively coupled to the management component 610. The optimized or effective bids produced by the analyzer component 120 are transmitted to the management component 610. The management component 610 manages or operates the advertisement system 600. For example, the management component 510 can accept bids for a plurality of keywords 620 and assigns slots to advertisers for keywords based on the value of the bids. Thus, FIG. 6 illustrates the integration of a bid optimization system comprising components 110 and 120 within the advertisement system 600.

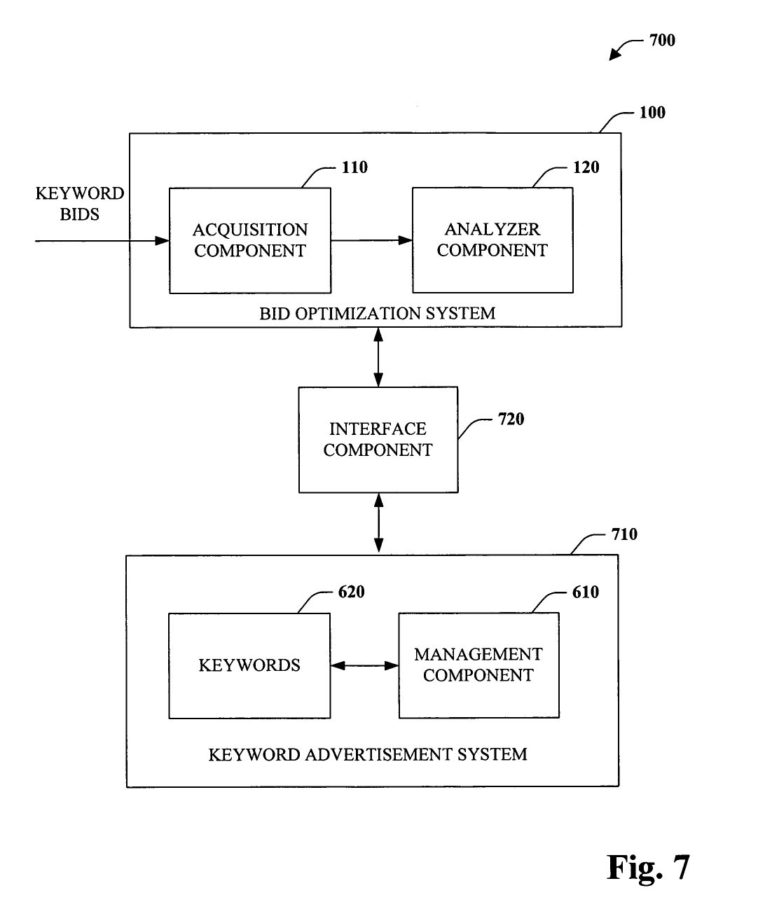

FIG. 7 depicts an advertisement system 700 in accordance with an aspect of the subject innovation. System 700 includes a bid optimization system 100 and a keyword advertisement system 710. As previously described, the bid optimization system 100 can include an acquisition component 110 and analyzer component 120. Acquisition component 110 acquires advertising data utilized by the analyzer component 120 to determine or generate optimal bids for keywords within a budget that maximize total utility and/or return on investment. The keyword advertisement system 710 includes management component 610 that controls manages the advertisement system. For instance, the management component 610 can facilitate auctioning keywords 620 and/or keyword/slot pairs. The bid optimization system 100 is separate from the keyword advertisement system 710. Interface 720 facilitates communication there between. In one instance, the interface 720 can be an application programming interface (API) that enables communication between the bid optimization system 100 and the advertisement system 710. For example, the bid optimization system 100 can employ the interface 720 to retrieve information from the ad system 710 necessary to generate bids that maximize total utility. Subsequently, bids can be transmitted to the ad system 710 utilizing the interface component 720.

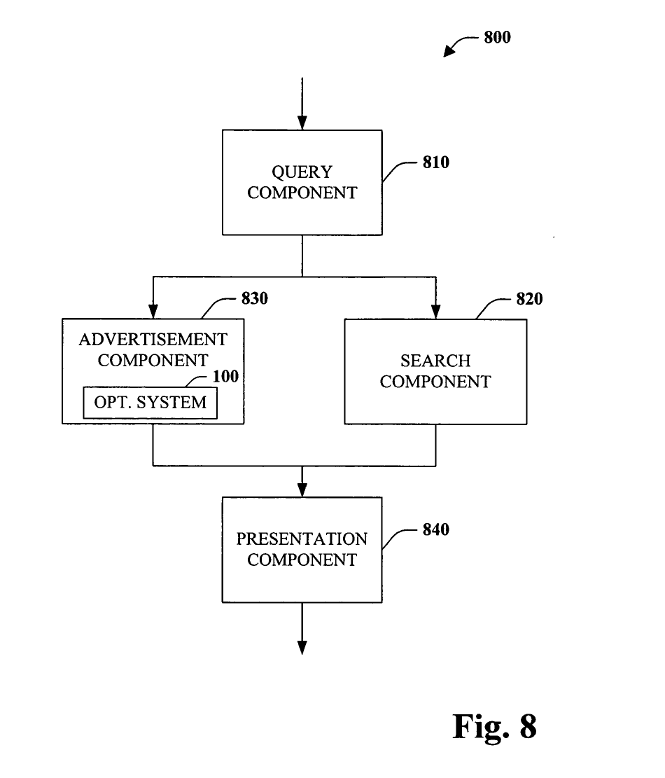

FIG. 8 provides an exemplary system 800 in which aspects of the subject innovation can be employed. System 800 is provided solely to provide context and is not meant to limit claimed aspects to the described system. The system 800 includes a query component 810. The query component 810 retrieves queries or requests for information. The query component 810 provides the received query to both the search component 820 and the advertisement component 830. The search component 820 processes the queries and retrieves the data that corresponds to the query. Furthermore, the search component 820 can provide relevancy scores that identify how pertinent the search results are to the query. Accordingly, search component 820 can correspond to a query processor or engine. The data can be queried from one or more of a local computer or storage device, a database, and network (e.g., intranet, internet . . . ). The advertisement component 830 can match the query words or phrases to keywords bid on or purchased by advertisers. The advertisement component 830 can include the bid optimization system 100 as previously described. The presentation component 840 can then received both advertisements and query results for display. For example, query results can be provided on the left side of a display while the advertisements or sponsored links can be provided on the right side.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

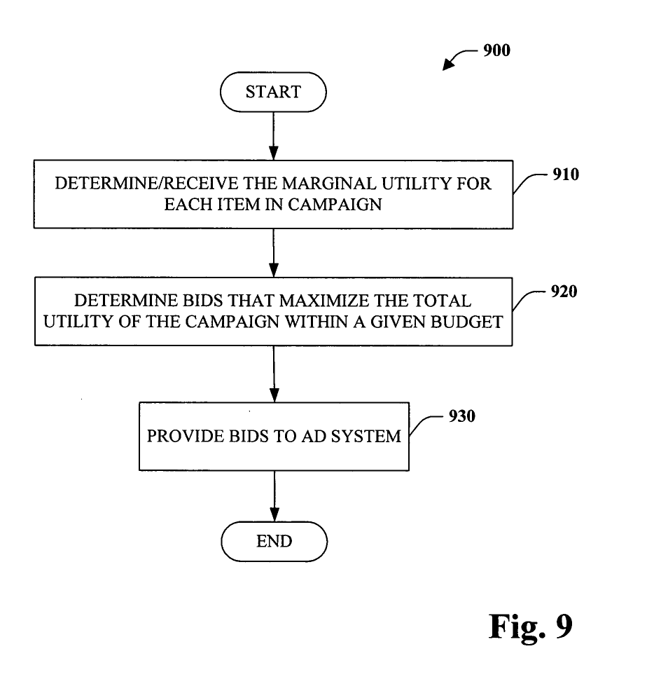

In view of the exemplary systems described supra, methodologies that may be implemented in accordance with the disclosed subject matter will be better appreciated with reference to the flow charts of FIGS. 9-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning to FIG. 9, a method bid optimization 900 is depicted in accordance with an aspect of the subject innovation. At reference numeral 910, the marginal utility for each item in a campaign is determined or otherwise obtained. The items may correspond to keywords but are not so limited. The utility of each keyword to an advertiser can correspond to the total utility that an advertiser derives from ads displayed for that keyword minus the cost of that keyword. Thus, utility of the advertiser is a function of spending. The advertiser may provide this utility or alternatively it can be derived from other data. For example, bids themselves or maximums set for the bids can be indicative of the utility supplied by keywords.

At numeral 920, bids are determined that maximize the total utility to an advertiser within a given budget. This determination can be a type of knapsack problem where the costs and utilities are analyzed to determine the optimal solution that satisfies a budget constraint. The determination can be started anew or based on modifications to provided bids. For instance, if the marginal utility of the keyword i is less than the marginal utility of the keyword j, then the total utility for the campaign can be improved by increasing the bid on j and decreasing the bid on i, subject to any constraints (e.g., effective bid not larger than original bid, constrained by budget . . . ). Accordingly, the marginal utility of an advertiser for j is decreased while the marginal utility of i is increased.

Other factors may also influence the bid determined by method 900. For instance, in order to extract more revenue from bidders without budget constraints, the bids of bidders with budget constrains may be decreased by as little as possible. By way of example and not limitation, if an ad is to be moved to a lower slot in order to decrease spending, the maximum value that would be required to move that ad to that slot should be bid. This is because this bid determines the payment for the ad above, which might come from an advertiser without budget constraints.

At reference numeral 930, the generated, determined or calculated bids for a keyword are provided to an ad system. The ad system can correspond to a keyword ad auction associated with search engine, for example, but is not limited thereto.

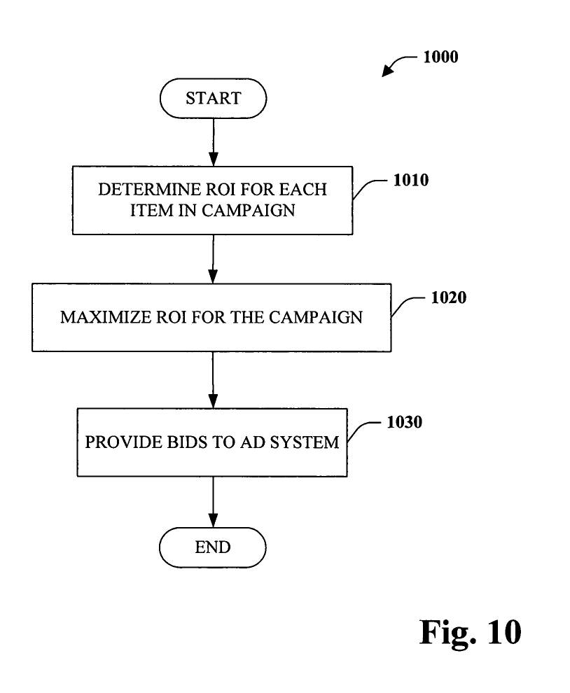

FIG. 10 is a flow diagram of a bid optimization method 1000 in accordance with an aspect of the innovation. At reference numeral 1010, the return on investment (ROI) for an item in an advertisement campaign is determined. The ROI can be employed to estimate the marginal utility of an advertiser for a keyword. The ROI for a keyword can be defined as the total utility that an advertiser derives from his/her ads on that keyword, divided by the payment for the keyword. The ROI can be determined exactly if enough data is available or alternatively all or portions thereof can be estimated based on other data indicative thereof such as bids or bid constraints. Consider a flower company that is willing to bid up to a dollar on the keyword “rose” and fifty cents on the word “daisy.” This is really expressing relative worth. Thus, a click coming from the word “rose” is worth twice as much as a click coming from the word “daisy.”

At numeral 1020, the return on investment is maximized for campaign items within a given budget. In accordance with one implementation, the ROIs can be equalized across all keywords. In particular, provided or generated keyword/slot pair bids can be altered to move keywords up and/or down. There is a variety of methods of choosing which keyword to move. One method is to select the keyword to move up is to pick the keyword with the maximum ROI or the keyword for which the slot above it has the highest ROI. Likewise, the keyword with the lowest ROI or the keyword where the slot to be moved to has the lower ROI, can be selected to move down. A keyword can be moved up a slot by increasing the bid if the budget is currently being under spent. A keyword can be moved down a slot by decreasing the bid if the budget is currently being over spent. Other rules can also be implemented such as only moving down a slot if the budget is over spent and after moving a keyword down the budget is still being over spent.

By way of example, if it turns out that the return on investment for the word “rose” is thirty cents and the return on investment for the word “daisy” is fifty cents. The method will try to lower the ROI on “daisy” and/or raise the ROI on “rose” until the two are equal. Furthermore, specified maximums are to be respected. For instance, a maximum allowable bid for “daisy” can be specified as fifty cents while the maximum for “rose” is one dollar. Depending on the current bids and ROIs, these maximum values may dictate particular bids for campaign items.

At reference numeral 1030, the generated or adjusted bids can be provided to an advertisement system. In accordance with one aspect of the innovation, the advertisement system can be an ad auction system associated with a search engine or the like. However, the subject innovation is not limited to implementation with respect to this type of system.

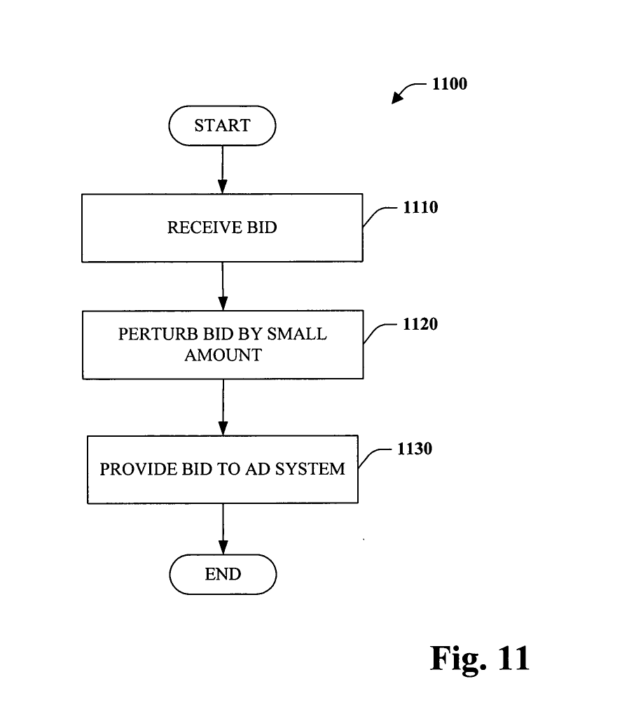

FIG. 11 is a flow chart diagram of a bid system 1100 in accordance with an aspect of the subject innovation. At numeral 1110, a bid is received. The bid may be an effective bid generated by an optimization methodology in accordance with one or more aspects of the claimed subject matter. At reference numeral 1120, the bid is perturbed slightly. For instance, a small negative random value can be added to each bid. This can prevent cycling and facilitate convergence on an equilibrium with high revenue when multiple users employ the same or similar bid methodologies or mechanisms. At 1130, the perturbed bid is provided to an advertising system.

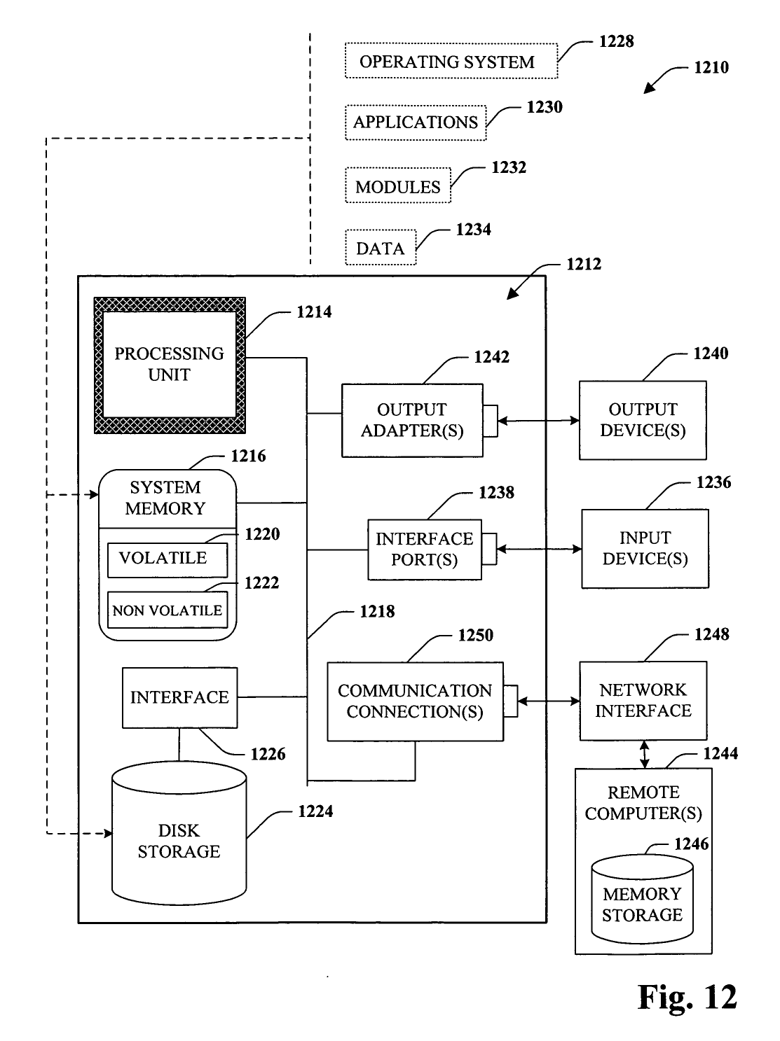

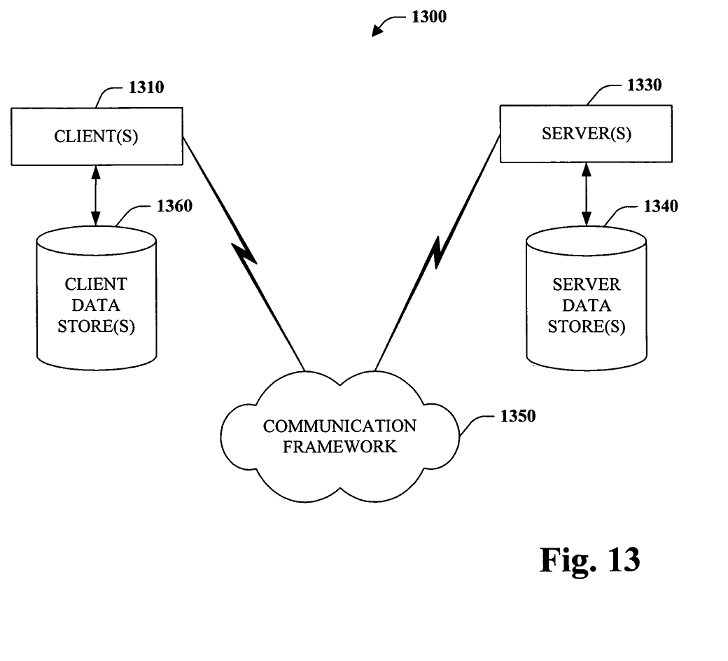

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216, and a system bus 1218. The system bus 1218 couples system components including, but not limited to, the system memory 1216 to the processing unit 1214. The processing unit 1214 can be any of various available microprocessors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example, disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212 and to output information from computer 1212 to an output device 1240. Output adapter 1242 is provided to illustrate that there are some output devices 1240 like displays (e.g., flat panel and CRT), speakers, and printers, among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1216, it can also be external to computer 1212. The hardware/software necessary for connection to the network interface 1248 includes, for exemplary purposes only, internal and external technologies such as, modems including regular telephone grade modems, cable modems, power modems and DSL modems, ISDN adapters, and Ethernet cards or components.

FIG. 13 is a schematic block diagram of a sample-computing environment 1300 with which the subject innovation can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the subject innovation, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. An advertisement campaign optimization system comprising the following computer executable components:
an acquisition component that receives bids associated with an ad campaign; and
an analyzer component that modifies the bids to maximize the total utility of the campaign within a budget.

2. The system of claim 1, the analyzer component includes a marginal utility component that determines the marginal utility of each keyword or ad.

3. The system of claim 2, the analyzer component includes an optimization component that computes the optimal bid and slot placement of campaign ads based on the marginal utility of each keyword or ad and the campaign budget.

4. The system of claim 1, the analyzer component includes a component that determines the return on investment associated with keywords or ads.

5. The system of claim 4, the analyzer component includes an optimization component that modifies bids in order to equalize the return on investment for campaign keywords or ads and maximize the return on investment for the campaign.

6. The system of claim 5, further comprising an intelligence component that generates values employed by the optimization component including price for keywords at various slots based on past values.

7. The system of claim 1, the analyzer component provides bids to a management component that operates an auction.

8. The system of claim 1, further comprising an interface component that facilitates interaction between the optimization system and a keyword advertising system.

9. An online ad campaign bid optimization system comprising:
a computer-implemented means for determining marginal utility to an advertiser for each keyword advertisement in the campaign; and
a computer-implemented means for generating bids that maximize the total utility for a campaign within a given budget.

10. A method of optimizing advertisement biding comprising the following computer executable acts:
computing marginal utility for each keyword in an advertising campaign; and
modifying bids to maximize total utility for the campaign based on a given budget.

11. The method of claim 10, computing marginal utility comprises calculating return on investment by subtracting the keyword cost from total utility derived from the keyword.

12. The method of claim 10, further comprising calculating the total utility for a keyword as U/k*floor(uᵢⱼ*k/U), where U is the maximum utility available from a slot within the budget, k is a large integer, and uᵢⱼ is the marginal utility for a word i at slot j.

13. The method of claim 10, modifying bids comprises decreasing bids on low return keywords and/or increasing bids on high return keywords.

14. The method of claim 13, decreasing the bid enough to obtain a lower ad slot.

15. The method of claim 13, increasing the bid enough to obtain a higher ad slot.

16. The method of claim 10, computing marginal utility comprises determining a ratio of relative worth based on keyword bids.

17. The method of claim 10, computing marginal utility comprises multiplying the bid for a keyword by the click through rate (CTR) for the keyword.

18. The method of claim 10, computing marginal utility comprises determining a ratio of relative worth based on specified maximum bids for keywords.

19. The method of claim 10, further comprising submitting the bids to an ad auction.

20. The method of claim 19, further comprising perturbing the bids slightly by adding or subtracting a small random value prior to selecting the winner of the auction.
